(19) United States
(12) Patent Application Publication
(10) Pub. No.: US 2014/0297763 A1
(43) Pub. Date: Oct. 2, 2014

(54) Method of Managing Networked Devices

(71) Applicant: Wistron Corporation, New Taipei City (TW)

(72) Inventors: JinGuang Wan, New Taipei City (TW); Xing Wang, New Taipei City (TW); Le Luo, New Taipei City (TW); Chia-Chieh Liu, New Taipei City (TW)

(21) Appl. No.: 13/927,118

(22) Filed: Jun. 26, 2013

(30) Foreign Application Priority Data
Mar. 28, 2013 (CN) 201310105511.5

(51) Int. Cl. H04L 12/58

(52) U.S. Cl. CPC H04L 51/18
USPC 709/206

(57) ABSTRACT

A method of managing networked devices for a control point in a network system is provided. The method includes listening to a discovery message transmitted from a networked device, wherein the discovery message indicates groups corresponding to the networked device, selecting at least one networked device according to a group, and transmitting a message to the at least one networked device for instructing the at least one networked device to execute or provide its service.

### BACKGROUND OF THE INVENTION

1. Field of the Invention

The present invention relates to a method of managing networked devices, and more particularly, to a method of managing networked devices utilized for a control point in a network system to manage the networked devices by classification.

2. Description of the Prior Art

Universal Plug and Play (hereafter called UPnP) is a network protocol allowing a device supporting the UPnP protocol to be automatically discovered and communicate with a host device without user's manual configuration, e.g. manual address configuring, when the device is connected to the host device. A connection between the device and the host device may be achieved via wired or wireless transmission protocol, such as Universal Serial Bus (USB), Bluetooth or a peripheral component interconnect express (PCI Express) protocol IEEE 1394.

A UPnP network system is set up on the basis of Internet Protocol (IP), Transmission Control Protocol (TCP), User Datagram Protocol (UDP), Hypertext Transfer Protocol (HTTP), Extensible Markup Language (XML) and other involved network technologies. Atypical architecture of the UPnP network system includes three types of fundamental members: UPnP devices, Services and Control Points. In addition, the UPnP device is used for realizing the services and may include a number of embedded devices, whereas the control point is responsible for discovering and controlling the UPnP devices to execute their services.

In order to operate in the UPnP network system, communication sessions between a UPnP device (hereafter called networked device) and a control point include: addressing, discovery, description, control, eventing and presentation stages. Take a network switch supporting the UPnP function for example. When the network switch is coupled to the computer host via a networking wire, a computer host may perform the communication sessions to automatically detect and add the network switch. Though a web page given by the network switch, a user may obtain detail information of the network switch, e.g. working states, and the user may configure related functions such as enable/disable a network port or to set a local area network (LAN) address.

In the discovery stage, when the networked device is physically added to the UPnP network system, the networked device may multicast a discovery message according to a simple service discovery protocol (SSDP) to broadcast its service to the control point in the UPnP network system. When a control point is connected to the UPnP network, the control point may search for networked devices of interest. During the discovery stage, only few items of more important information or information about services of the networked device would be provided, such as a device type, a universally-unique identifier (UUID), and a uniform resource locator (URL) of its description message.

However, the control point may pay attention to any networked devices which are online because the discovery message does not provide enough information about the networked devices, which may lead to message queuing and a high work loading of the control point. In such a situation, the networked devices may continuously multicast online broadcast since the control point is too busy to instantly response the networked devices, which may lead to a traffic jam of the UPnP network system, increase a probability of packet collision as well as increase a number of missing packets. Besides, the control point may have a difficulty to efficiently search for the networked devices of interest and manage the networked devices by classification during the discovery stage because the control point can not screen discovery messages of interest due to insufficient information.

On the other hand, the control point may be notified that the networked device is offline according to an offline broadcast transmitted from the networked device. However, the offline broadcast could be lost due to the traffic jam, such that the control point may not be notified the networked device is offline instantly, and neither be notified to make sure whether the services provided by the networked device are still available.

Therefore, there is a need to improve the prior art to solve the above problems.

### SUMMARY OF THE INVENTION

It is therefore an objective of the present invention to provide a method of managing networked devices for a control point in a network system to solve the abovementioned problems.

An embodiment of the invention discloses a method of managing networked devices for a control point in a network system. The method includes listening to a discovery message transmitted from a networked device, wherein the discovery message indicates groups corresponding to the networked device, selecting at least one networked device according to a group; and transmitting a message to the at least one networked device for instructing the at least one networked device to execute or provide its service.

An embodiment of the invention further discloses a method of managing networked devices for a control point in a network system. The method includes retrieving a validity period according to the discovery message, timing and transmitting a handshaking request to the networked device if a next discovery message transmitted from the networked device is not listened to during the validity period; and listening to a handshaking response transmitted from the networked device to determine whether the networked device is online.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system.

FIG. 2 is a schematic diagram of a process of managing networked devices according to an embodiment of the invention.

FIG. 3 is a schematic diagram of a process of managing networked devices according to another embodiment of the invention.

### DETAILED DESCRIPTION

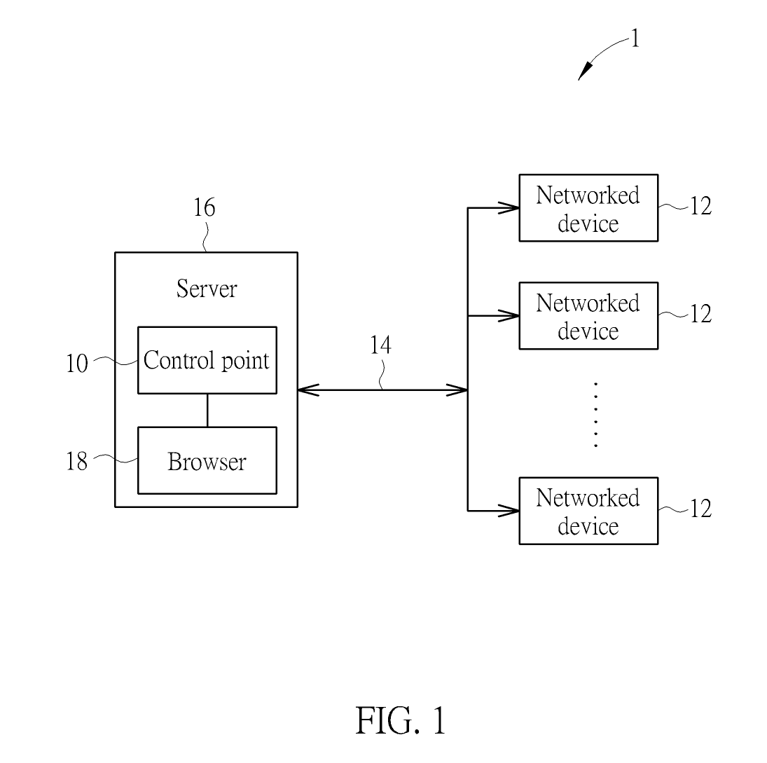

Please refer to FIG. 1, which is a schematic diagram of a network system 1. The network system 1 maybe a Universal Plug and Play network system. The network system 1 includes a control point 10 and a plurality of networked devices 12. The networked devices 12 may be any kind of electronic device supporting UPnP functions, such as a network switch, a mobile device, a household appliance and so on. The networked device 12 may connect to the control point 10 via a local area network (hereafter called LAN) 14. The control point 10 may exist in a server 16, and the control point 10 may present information about the networked device 12 to a user via a browser 18.

The following description illustrates how the control point 10 may manage the networked devices 12 by classification and make sure whether the networked device 12 is online or offline in the network system 1.

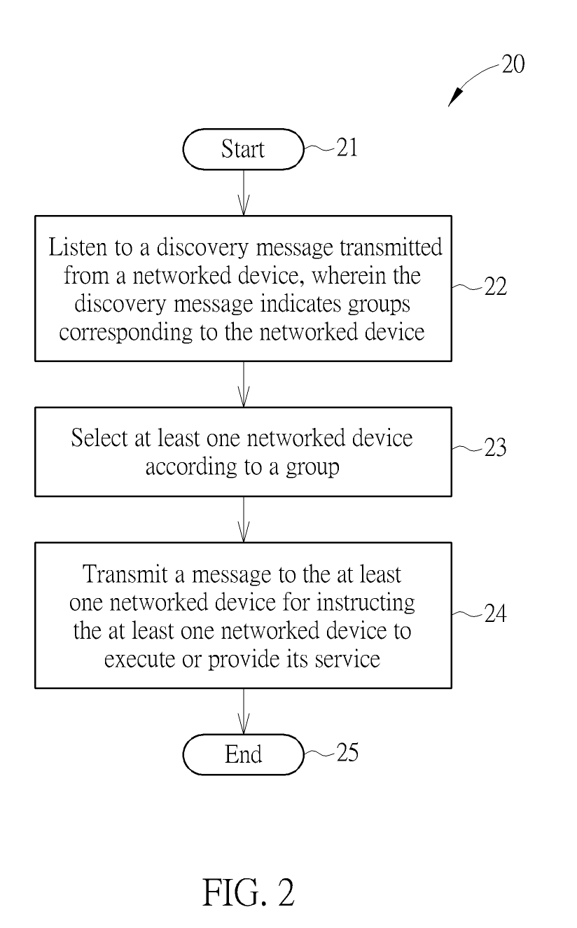

First, please refer to FIG. 2, which is a schematic diagram of a process of managing networked devices 20 according to an embodiment of the invention. The process of managing networked devices 20 may be utilized in the control point 10 shown in FIG. 1, and may be compiled into a program code or a an application program interface (API), such that the networked devices 12 may provide information about groups to which the networked devices 12 are belonged when the networked devices 12 are added to the network system 1. As a result, the control point 10 may classify the networked devices 12 according to their groups to achieve device management. As shown in FIG. 2, the process of managing networked devices 20 includes the following steps:

Step 21: Start.

Step 22: Listen to a discovery message transmitted from a networked device, wherein the discovery message indicates groups corresponding to the networked device.

Step 23: Select at least one networked device according to a group.

Step 24: Transmit a message to the at least one networked device for instructing the at least one networked device to execute or provide its service.

Step 25: End.

According to the process of managing networked devices 20, the discovery message may indicate groups corresponding to the networked device, such that the control point may classify the networked device, select the networked devices of interest, and determine whether to perform further interactions with the networked devices of interest according to the discovery message. For example, the control point may transmit a message to the networked device of interest for instructing the networked devices of interest to execute or provide their services. Or, the control point may multicast a broadcast message for searching for the networked device of interest corresponding to a specific group.

Specifically, when the networked device 12 is added to the network system 1, the networked device 12 may multicast a discovery message as follows:

NOTIFY*HTTP/1.1

Server: Linux/2.6.36.3 UPnP/1.0 Wistronits/2.0

Cache-Control: max-age=180

Location: http://10.50.141.90:4004/description.xml

NTS: ssdp:alive

NT: upnp:rootdevice_swpc

USN:uuid:EBE0B9A597635C_Y::upnp:rootdevice_swpc

HOST: 239.255.255.250:1901

According to the discovery message above, “Server: Linux/2.6.36.3 UPnP/1.0 Wistronits/2.0” may indicate that a product name of the networked device 12 is “Wistronits”. “NT:upnp:rootdevice_swpc” may indicate a notification type (NT) of the discovery message, which means the discovery message is transmitted from a root device named “rootdevice_swpc”. “USN:uuid:EBE0B9A597635C_Y” may indicate a Unique Service Name (USN), which means a Universally Unique Identifier (hereafter called UUID) of the networked device 12 is “EBE0B9A597635C_Y”. Functions and corresponding names for the rest of descriptions illustrated in the discovery message are well known in the art, which is omitted.

Noticeably, the product name “Wistronits”, the root device “rootdevice_swpc” and the UUID “EBE0B9A597635C_Y” may further indicate groups to which the networked device belong, e.g. a network domain, a group of users and a service type, such that the control point may select services and control actions of the networked devices according to their groups, so as to achieve device management by classification.

For example, the product name “Wistronits” may indicate a network domain. For example, if the control point searched a plurality of networked devices having a same product name, it may be referred that the plurality of networked devices belongs to a same network domain, or the plurality of networked devices is added to the network system 1 via a same LAN. As a result, the control point may manage or monitor the networked devices among the same domain or different domains to respectively control services provided by the networked devices. For example, the control point may manage networked devices belonging to different companies and vendors based on their network domains.

Moreover, a suffix “swpc” of the root device “rootdevice_swpc” may indicate a group of users, which may be referred that the networked devices having a same suffix may belong to a group of users to operate relative functions. For example, networked devices belonging to a software develop department may have the suffix “swpc”, which means that the networked devices having the suffix “swpc” may operate for developing software programs. While networked devices belonging to a hardware develop department may have the suffix “hwpc”, which means that the networked devices having the suffix “hwpc” may operate for developing hardware devices. As a result, a manage range of the control point may narrow from a LAN domain down to a smaller department or a group of users to manage the networked devices in a proper range.

On the other hand, a suffix “Y” of the UUID “EBE0B9A597635C_Y” may indicate a service type, which maybe referred that the networked devices having a same service type may provide a same service or relative services. For example, a personal computer or a server may provide a service of data processing; a broadcaster, a video camera and an audiovisual equipment may provide a service of playing multimedia; and large electronic devices or small household appliances may provide different types of services. As a result, when the control point desires to use the service corresponding to the suffix “Y”, the control point may multicast a discovery message containing the suffix “Y” to search for the networked devices having the suffix “Y” to perform their services, so as to manage and control some targeted devices.

Simply speaking, the discovery message of the present invention may include information for indicating groups to which the networked device belong, such as a network domain, a group of users and a service type. Hence, the control point may manage the networked devices by classification according to the information. The control point may not pay attention to all of the networked devices in the network system to mitigate the problems of business and message queuing. In addition, since the control point may screen the discovery messages during the discovery stage, the control point may search for devices belonging to a specific group by transmitting a message for searching or instructing the devices belonging to the specific group to execute their services, which may improve an efficiency of device searching. In practice, the control point may select at least one networked device according to one group or multiple groups to transmit the message for searching or instructing the at least one network device to execute their services, so as to manage and control some targeted devices.

When the control point desires to search for networked devices belonging to a specific group, the control point may multicast a broadcast message as follows:

ST: upnp:rootdevice

MX: 5

MAN: “ssdp:discover_swpc”

HOST: 239.255.255.250:1901

Content-Length: 0

According to the above broadcast message, “ST:upnp:rootdevice” may indicate a search target (ST) which the control point desires to search is a root device. “MAN: “ssdp:discover_swpc”” may indicate the root device which the control point desires to search corresponding to a specific group, wherein the suffix “swpc” indicates a group of users. Therefore, the network devices having the suffix “swpc”, e.g. belonging to a software department, may return search responses to the control point once the broadcast message is received.

The following search response is returned from the networked device according to the broadcast message transmitted by the control point:

HTTP/1.1 200 OK

Content-Type: text/html; charset=“utf-8”

Server: Linux/2.6.36.3 UPnP/1.0 Wistronits/2.0

Content-Length: 0

Cache-Control: max-age=180

EXT:

Date: Fri, 2 Jan. 2009 22:20:57 GMT

ST: upnp:rootdevice

USN:uuid:EBE0B9A597635C_Y::upnp:rootdevice_swpc

Location: http://10.50.141.90:4004/description.xml

MYNAME: Leon

According to the above search response, the search response returned from the networked device may include a suffix “Y” indicating a service type and a product name “Wistronits” indicating a network domain, such that the control point may manage and classify the networked device accordingly. In addition, “MYNAME: Leon” further indicates an individual user, thereby the manage range of the control point may narrow down to a single networked device to realize peer to peer communications. As a result, based on the above embodiments, the manage range of the control point may cover from a large area such as a network domain, a middle or small range such as a group of users and a service type and down to a single networked device, such that the control point may perform one to many or peer to peer communications, and manage and control the networked devices in proper and specific ranges.

The following offline message is transmitted from the networked device to notify the control point that the networked device is offline:

NOTIFY*HTTP/1.1

NTS: ssdp:byebye

NT: upnp:rootdevice_swpc

USN:uuid:EBE0B9A597635C_Y::upnp:rootdevice_swpc

HOST: 239.255.255.250:1901

According to the above offline message, the control point may be notified a networked device which is a root device belonging to a group of users “swpc” and having a service type “Y” has left the system once the offline message is received, thereby the control point may stop monitoring or stop managing the networked device.

Besides, at the first time the networked device is connected to the network system, the networked device may multicast discovery messages to increase a probability of being heard by the control point. For example, the networked device may multicast N discovery messages at one time. However, if all of the online networked devices continuously multicasts discovery messages or online broadcasts, the traffic jam may become worse and lead to missing of the offline broadcast. Therefore, the networked device may periodically transmit one discovery message or one online broadcast other than the first to show up, which may mitigate the traffic jam.

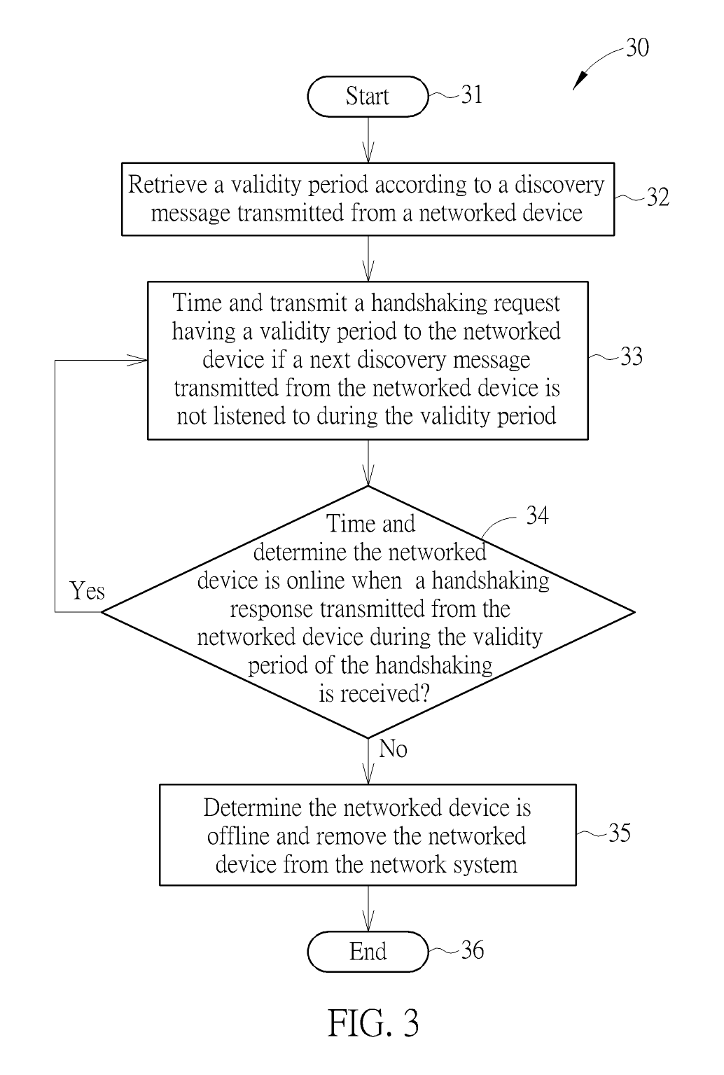

Please refer to FIG. 3, which is a schematic diagram of a process of managing networked devices 30 according to another embodiment of the invention. The process of managing networked devices 30 may be utilized in the control point 10 shown in FIG. 1 and may be compiled into a program code or an application interface, such that the control point 10 may determine whether the networked device 12 is active or inactive to make sure that the networked device 12 is online or offline. As shown in FIG. 3, the process of managing networked devices 30 includes the following steps:

Step 31: Start.

Step 32: Retrieve a validity period according to a discovery message transmitted from a networked device.

Step 33: Time and transmit a handshaking request having a validity period to the networked device if a next discovery message transmitted from the networked device is not listened to during the validity period.

Step 34: Time and determine the networked device is online when a handshaking response transmitted from the networked device during the validity period of the handshaking is received? Return to step 33 if yes. Go to step 35 if no.

Step 35: Determine the networked device is offline and remove the networked device from the network system.

Step 36: End.

The process of managing networked devices 30 is to accurately make sure whether the networked device is online or not, and avoid the control point 10 from misjudging that the networked device is offline due to missing discovery messages or missing online broadcasts. According to the process of managing networked devices 30, the control point may perform timing to determine whether a validity period TD of the discovery message is due. For example, the control point may accumulate an inactive time TS of the networked device. When the validity period TD of the discovery message is due, i.e. the inactive time TS of the networked device is greater than the validity period TD (TS>TD), the control point may transmit a handshaking request to the networked device for requesting the networked device to return a handshaking response. A validity period TH of the handshaking request may be set by the control point, and the control point may continue to accumulate the inactive time TS of the networked device. If the control point receives the handshaking response responded from the networked device within the validity period TH of the handshaking request, the control point may know that the networked device is still online and its service is available. In other words, if TS<(TD+TH), which may indicate that the validity period TH of the handshaking request does not expire, the control point may know that the networked device is still online accordingly. In contrast, if TS>(TD+TH), which may indicate that both of the validity period TD of the discovery message and the validity period TH of the handshaking request have expired, and the control point may know that the networked device is offline and remove the networked device from the UPnP network system accordingly.

For example, the discovery message shown in the first embodiment and the search response shown in the third embodiment, both of which include “Cache-Control: max-age=180” for indicating a validity period TD of the discovery message and the search response is 180 seconds. Take the discovery message for example, when the validity period TD is due, the networked device may transmit the discovery message or online broadcast again to continuously broadcast its existence to the control point. The control point may determine whether the networked device is online and its service is available by listening to the online broadcast periodically transmitted from the networked device, or by transmitting the handshaking request and receiving the handshaking response returned from the networked device.

In the above embodiments, the control point and networked device may transmit the discovery message according to a simple service discovery protocol (SSDP). Noticeably, “HOST: 239.255.255.250:1901” may indicate that the control point and networked device use a port 1901 to transmit messages. The UPnP protocol defines a port 1900 to transmit messages in the UPnP network system, while there are less messages transmitted on the port 1901, which may mitigate the traffic jam in the network system.

In addition, messages transmitted between the control point and the networked device are not limited to using a same file format or coding language, e.g. XML, for encoding/decoding. For example, the control point may transmit a control message encoded/decoded according to XML to the networked device for requesting the networked device to provide a screen shot; and the networked device may return the screen shot encoded/decoded according to a HyperText Markup Language (HTML).

Please note that, relative steps in the processes of managing networked devices 20 and 30 shown in FIG. 2 and FIG. 3 may be applied in the control point separately or with combination to manage the networked devices by classification, those skilled in the art may make modifications or alterations accordingly to meet practical requirements.

To sum up, the discovery message of the present invention may include information for indicating groups to which the networked device belong, such as a network domain, a group of users and a service type. Therefore, the control point may manage the networked devices by classification according to the information. The control point may not pay attention to all of the networked devices in the network system to mitigate the problems of business and message queuing. In addition, since the control point may screen the discovery messages during the discovery stage, the control point may search for devices belonging to a specific group by transmitting a message for searching or instructing the devices belonging to the specific group to execute their services, which may improve the efficiency of device searching. In practice, the control point may select at least one networked device according to one group or multiple groups to transmit the message for searching or instructing the at least one network device to execute their services, so as to manage and control some targeted devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing networked devices for a control point in a network system, comprising:
listening to a discovery message transmitted from a networked device, wherein the discovery message indicates groups corresponding to the networked device;
selecting at least one networked device according to a group; and
transmitting a message to the at least one networked device for instructing the at least one networked device to execute or provide its service.

2. The method of claim 1, wherein the group indicates a network domain, a group of users or a service type.

3. The method of claim 1, wherein the step of transmitting a message to the at least one networked device for instructing the at least one networked device to execute or provide its service comprises:
selecting a group and transmitting a message for searching for networked devices corresponding to the group.

4. The method of claim 1, further comprising:
retrieving a validity period according to the discovery message;
timing and transmitting a handshaking request to the networked device if a next discovery message transmitted from the networked device is not listened to during the validity period; and
listening to a handshaking response transmitted from the networked device to determine whether the networked device is online.

5. The method of claim 4, wherein the step of listening to the handshaking response transmitted from the networked device to determine whether the networked device is online comprises:
timing to determine the networked device is online if the handshaking response transmitted from the networked device is responded during the validity period of the handshaking request, so as to time the validity period of the discovery message again; and
timing to determine the networked device is offline if the handshaking response transmitted from the networked device is not responded during the validity period of the handshaking request, so as to remove the networked device from the network system.

6. The method of claim 1, wherein the discovery message further indicates an individual user.

7. The method of claim 1, wherein the discovery message is transmitted by using a port 1901 according to a simple service discovery protocol.

8. The method of claim 1, wherein the network system is a universal plug and play network system.

9. A method of managing networked devices for a control point in a network system, comprising:
retrieving a validity period according to the discovery message;
timing and transmitting a handshaking request to the networked device if a next discovery message transmitted from the networked device is not listened to during the validity period; and
listening to a handshaking response transmitted from the networked device to determine whether the networked device is online.

10. The method of claim 9, wherein the step of listening to the handshaking response transmitted from the networked device to determine whether the networked device is online comprises:
timing to determine the networked device is online if the handshaking response transmitted from the networked device is responded during the validity period of the handshaking request, so as to time the validity period of the discovery message again; and
timing to determine the networked device is offline if the handshaking response transmitted from the networked device is not responded during the validity period of the handshaking request, so as to remove the networked device from the network system.

11. The method of claim 9, wherein the discovery message indicates groups corresponding to the networked device, the method further comprising:
selecting at least one networked device according to a group; and
transmitting a message to the at least one networked device for instructing the at least one networked device to execute or provide its service.

12. The method of claim 11, wherein the group indicates a network domain, a group of users or a service type.

13. The method of claim 11, wherein the step of transmitting a message to the at least one networked device for instructing the at least one networked device to execute or provide its service comprises:
selecting a group and transmitting a message for searching for networked devices corresponding to the group.

14. The method of claim 11, wherein the discovery message further indicates an individual user.

15. The method of claim 9, wherein the discovery message is transmitted by using a port 1901 according to a simple service discovery protocol.

16. The method of claim 9, wherein the network system is a universal plug and play network system.
